(19) United States
(12) Patent Application Publication
(10) Pub. No.: US 2017/0169330 A1
(43) Pub. Date: Jun. 15, 2017

(54) Method and Electronic Device for Displaying Play Content in Smart Television

(71) Applicants: Le Holdings (Beijing) Co., Ltd., Beijing (CN); Le Shi Zhi Xin Electronic Technology (Tianjin) Limited, Tianjin (CN)

(72) Inventor: Jianyong Cui, Tianjin (CN)

(21) Appl. No.: 15/247,116

(22) Filed: Aug. 25, 2016

Related U.S. Application Data
(63) Continuation of application No. PCT/CN2016/088553, filed on Jul. 5, 2016.

(30) Foreign Application Priority Data
Dec. 15, 2015 (CN) 201510953575X

(51) Int. Cl. G06N 3/08; H04N 21/25

(52) U.S. Cl. CPC G06N 3/08; H04N 21/251; H04L 67/42

(57) ABSTRACT

Disclosed are a method and electronic device for displaying play content on a smart television, which relates to the field of television service technology and solves the technical problems in the prior art that the amount of operation of a user in searching a film is large and the view experience of the user is thus influenced because there is no intelligent film recommendation function on a television terminal. Wherein, the method includes the following steps: receiving view data of a user in watching transmitted by a television terminal; predicting, according to the view data, recommended film having high correlation with the view data; and, feeding back the predicted recommended film to the television terminal so as to recommend the recommended film to the user.

### CROSS REFERENCE TO RELATED APPLICATIONS

This application is a continuation of International Application No. PCT/CN2016/088553, filed on Jul. 5, 2016, which is based upon and claims priority to Chinese Patent Application No. 201510953575X, filed on Dec. 15, 2015, the entire contents of which are incorporated herein by reference.

### TECHNICAL FIELD

The present disclosure relates to the field of television service technology, and in particular, relates to a method and electronic device for displaying play content on a smart television.

### BACKGROUND

As one of intelligent multimedia terminals emerging in compliance with the trend of “high-definition”, “networked” and “intelligent” televisions, smart televisions have functions of acquiring program contents from Internet, video equipment, computers or other various channels and clearly displaying, on a large screen, contents most needed by consumers via a simple integrated operation interface easy to use. In comparison with an application platform of a conventional television, a smart television may realize web search, network television, Video On Demand (VOD), digital music, network news, network video telephone and other various application services. At present, there are many program contents available for users to watch on a smart television, and the program contents may be searched on the whole network for watching due to the characteristic of the Internet, so the quick and precise positioning of the program contents seems to be particularly important.

During implementation of the present disclosure, the inventor(s) find(s) that there are few recommended films in an existing smart television, and the present recommendation function is compulsive recommendation autonomously performed by manufacturers, which diverge from the user-centered concept. A user expects that what film the user wants to watch is at the most conspicuous position, so that the user may quickly watch the film and does not worry about searching the film source.

In the prior art, a user can only know the name of a target film clearly and then searches the target film for watching if the user wants to watch a certain type of films. There usually are two ways: (1) entering the type and then searching layer by layer; and (2) finding through a search function.

However, in many cases, the user does not know the name of a film clearly, but is likely to want to watch only a certain type or certain kind of films of interest. There will be a very large amount of operation if the film is found out by searching. Therefore, such a way to acquire a desired film by searching in the prior art will bring about tedious operations for a user, consumes the time of the user and thus influences the view experience of the user.

### SUMMARY

Embodiments of the present disclosure provide a method and electronic device for displaying play content on a smart television, in order to solve the technical problems in the prior art that the amount of operation of a user in searching a film is large and the view experience of the user is thus influenced because there is no intelligent film recommendation function on a television terminal.

In one aspect, an embodiment of the present disclosure provides a method for displaying play content on a smart television, the method being applicable to a server and mainly including the following steps: receiving view data of a user in watching transmitted by a television terminal; predicting, according to the view data, a recommended film having high correlation with the view data; and feeding back the predicted recommended film to the television terminal so as to recommend the recommended film to the user.

In another aspect, an embodiment of the present disclosure provides an electronic device, including: at least one processor; and a memory communicably connected with the at least one processor for storing instructions executable by the at least one processor, wherein execution of the instructions by the at least one processor causes the at least one processor to: receive view data of a user in watching transmitted by a television terminal; predict, according to the view data, a recommended film having high correlation with the view data; and feedback the predicted recommended film to the television terminal so as to recommend the recommended film to the user.

In another aspect, an embodiment of the present disclosure provides a non-transitory computer-readable storage medium storing executable instructions that, when executed by an electronic device, cause the electronic device to: receive view data of a user in watching transmitted by a television terminal; predict, according to the view data, a recommended film having high correlation with the view data; and feedback the predicted recommended film to the television terminal so as to recommend the recommended film to the user.

By the method and electronic device for displaying play content on a smart television provided by the present disclosure, what type of films a user likes watching may be predicted according to the view data of the user, and the same type of films are displayed on a screen at a television terminal and then recommended to the user, thus solving the technical problems in the prior art that the operation of the user in searching films is not convenient and an operator compulsively recommends films what the user does not want to watch. Furthermore, the technical effects of improving the precision of searching and recommending films, facilitating film watching of the user and enhancing the view experience of the user are realized.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flowchart on a television terminal of a method for displaying play content on a smart television according to some embodiments of the present disclosure;

FIG. 2 is a flowchart on a server of a method for displaying play content on a smart television according to some embodiments of the present disclosure;

FIG. 3 is a schematic diagram of a forward propagation algorithm in a method for displaying play content on a smart television according to some embodiments of the present disclosure;

FIG. 4 is a schematic diagram of an error backpropagation algorithm in a method for displaying play content on a smart television according to some embodiments of the present disclosure;

FIG. 5 is a schematic diagram of a BP prediction network in a method for displaying play content on a smart television according to some embodiments of the present disclosure;

FIG. 6 is a schematic flowchart of a method for displaying play content on a smart television according to some embodiments of the present disclosure;

FIG. 7 is a structural schematic diagram of an apparatus for displaying play content on a smart television on a television terminal according to some embodiments of the present disclosure;

FIG. 8 is a structural schematic diagram of an apparatus for displaying play content on a smart television on a server according to some embodiments of the present disclosure;

FIG. 9 is a structural schematic diagram of a system for displaying play content on a smart television according to some embodiments of the present disclosure; and

FIG. 10 is a structural schematic diagram of an apparatus for displaying play content on a smart television according to some embodiments of the present disclosure.

### DETAILED DESCRIPTION

Preferred embodiments of the present disclosure will be illustrated in conjunction with the drawings. It should be appreciated that the preferred embodiments described herein are merely used for illustrating and explaining the present disclosure, rather than limiting it.

To make the objectives, technical solutions and advantages of the embodiments of the present disclosure clearer, the technical solutions in the embodiments of the present disclosure will be described clearly and completely in conjunction with the drawings in the embodiments of the present disclosure. Apparently, the described embodiments are a part, but not all of the embodiments of the present disclosure. All other embodiments obtained by a person of ordinary skill in the art without creative effort on the basis of the embodiments in the present disclosure are within the protection scope of the present disclosure.

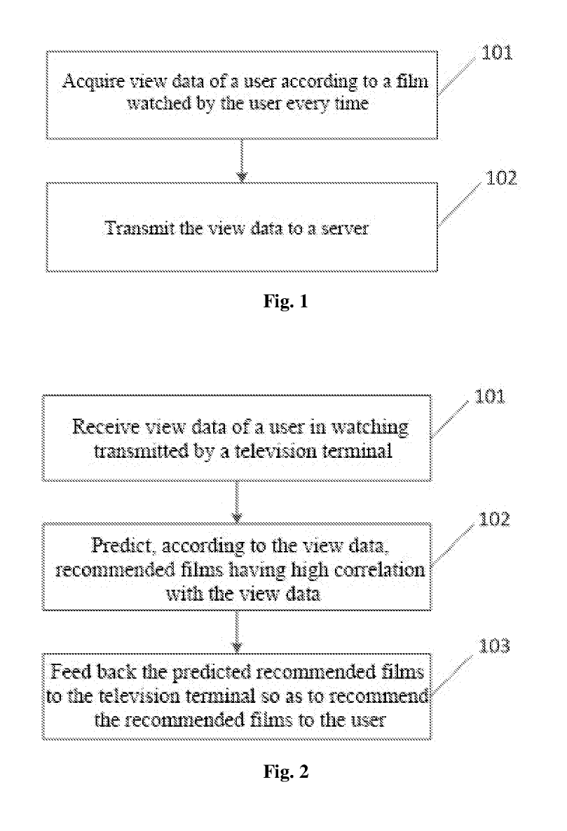

As shown in FIG. 1, the embodiment provides a method for displaying play content on a smart television. The method is suitable for arrangement on a television terminal and mainly includes the following steps.

101: View data of a user according to a film watched by the user every time is acquired. The view data includes the name and category tag of each film. It will be usually recoded on the television terminal that the user clicks which film every time for watching, so the view data of a film already watched by the user, including the name and category tag of the film, may be obtained according to the record.

102: The view data is transmitted to a server.

It is possible that the television terminal actively sends the view data of the user to the server regularly, or it is also possible that the server inquires the view data of the user. Sending the view data of the user to the server is to provide convenience for the server to predict, according to the view data of the user, what type of films the user likes watching and then feed back the corresponding film type as recommended film to the television terminal. Therefore, the above solution further includes: receiving recommended film, having high correlation with the film watched by the user, fed back by the server; and, displaying the recommended film to the user.

In the method provided by the embodiment, the television terminal only needs to send the view data of the user to the server terminal, so it is convenient for the server terminal to predict recommended film. Moreover, as the prediction process is performed on the server, the load of the television terminal is reduced, and the view demand of the user can also be met.

Corresponding to the method applicable on the television terminal, as shown in FIG. 2, the embodiment further provides a method for displaying play content on a smart television, which is suitable for arrangement on a server. The method mainly includes the following steps: 201: View data of a user in watching transmitted by a television terminal is received, and 202: Recommended film having high correlation with the view data are predicted according to the view data. The films having high correlation with the film type in the view data usually are films that the user likes, so these films are suitable for being recommended to the user as recommended film. The precision of prediction of recommended film in the present disclosure depends on a recommendation algorithm in addition to the name and category tag of the film watched by the user every time. By using the name and category tag of the film watched by the user every time as an input sample and then inputting the input sample into the recommendation algorithm to perform multiple times of repeated training, the predictability of the recommendation algorithm will be more and more precise, and a training result obtained after multiple times of training is regarded as the finally predicted recommended film having high correlation with the view data and then recommended to the user.

The recommendation algorithm provided in the embodiment will be specifically described below.

The neural network algorithm is a widely used algorithm of machine learning algorithms. The BP (Backpropagation) algorithm is also referred as a backpropagation algorithm. By calculating the error of backpropagation, the calculation degree is precise, so it is referred to as the backpropagation algorithm. The two algorithms may used as the recommendation algorithm in the embodiment. As a whole, the algorithm description is divided into two stages, which are a training stage and a prediction stage respectively.

1. Training Stage

A sample and a target corresponding to the sample are input, and a preliminary target value is obtained through forward calculation and then compared with a precise target value. Subsequently, the error is backpropagated to reduce a difference between the output value and a preset target value, until the error is reduced the preset prediction standard value.

(1) Data preparation: the input sample is a film name and each film name is marked with a plurality of tags, for example, 10 tags. The 10 tags are used as features for training. The input result (i.e., target) is the category tag (type) of a film, for example, a certain type of film is marked with 10 tags as features for identifying the film.
(2) Network construction: in general, the finer the classification is, the more complicated the network structure is. Here, the network having one intermediate layer is used. (a) Forward transmission A sample is input to an input layer, and then multiplied by a corresponding weight through an operation of a weight matrix. The mathematical expression is as shown by

$${A}_{j} ( \overline{x} , \overline{w} ) = WX = {\sum }_{i = 1}^{m} {x}_{i} {w}_{ji} \qquad ( 1 )$$

the following formula (1):

wherein, Aⱼ is the output of the j^{th} layer, x̅ and w̅ schematically represent elements in matrixes X and W, respectively, W represents a weight matrix, and X represents an input sample (data) matrix. The calculation method is as described above: the weight matrix is multiplied by the input sample matrix. Both Xᵢ and Wⱼᵢ are elements of corresponding matrixes.

Particularly, in the embodiment, considering that the weight matrix W directly influences the effectiveness of the formula (1), the initial value of W is obtained through a special dictionary training algorithm K-SVD. The K-SVD is a mathematical algorithm. A matrix may be decomposed to obtain the most concerned part, i.e., feature.
Therefore, it can be seen that the output of a neuron depends on the input of a signal and a weight value (weight), and the non-linear sigmoid is selected as an activation function for facilitating calculation. The output of the activation function is as shown by the following formula (2).

$${O}_{j} ( \overline{x} , \overline{w} ) = \frac{1}{1 + {e}^{{A}_{j} ( \overline{x} , \overline{w} )}} \qquad ( 2 )$$

wherein, Oⱼ is the output of the j^{th} layer after the activation function.

The activation function uses sigmoid. For a larger input value (the structure obtained after multiplying the sample by the weight, it tends to be 1. When the input is 0, the activation output is 0.5; however, when the negative value of the input value tends to be very small, the activation output is 0. Particularly, in the embodiment, the curve of the activation function is smoothed before use, so that a gradient operation may be performed and the accuracy of operation is also improved.

The purpose of the training process is to obtain an ideal output for a given input. The initially selected weight is certainly not optimal, so there will be a residual error between the target and the actual output, as shown by the following formula (3).

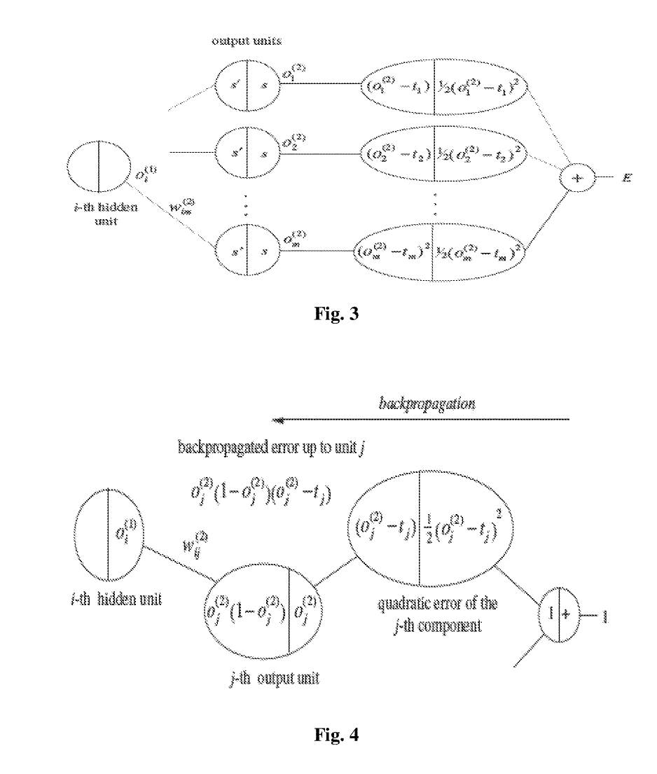

E ⱼ(x̅, w̅, tⱼ)=|Oⱼ(x̅, w̅)−tⱼ|² (3)

wherein Eⱼ is an error between the actual output and the real value, which is generally used as a target for optimization, and tⱼ is the target output of the j^{th} layer, i.e., the real output value corresponding to the sample, as shown in FIG. 3.

After errors are squared, all the errors are positive values, and the error values of all the samples are accumulated to obtain the following mathematical model (4):

$$E ( \overline{x} , \overline{w} , \overline{t} ) = {\sum }_{j} {\vert {O}_{j} ( \overline{x} , \overline{w} ) - {t}_{j} \vert}^{2} \qquad ( 4 )$$

(b) Error backpropagation

In the forward propagation, the relation how the error depends on the input sample, output and the weight has been obtained. After the relation is found, the task becomes how to update the weight according to the error to obtain an optimal weight so as to obtain the network. During calculating and updating the weight, a random gradient descent algorithm is used, as shown by the following formula (5).

$$Δ w ( k + 1 ) = α Δ w ( k ) + η ( 1 + α ) \frac{\partial E}{\partial w} \qquad ( 5 )$$

wherein Δw(k+1) and Δw(k)represent updates of the weight after the (k+1)^{th} iteration and the k^{th} iteration, respectively, and α and ƒ are two constant parameters, one of which is used for equilibrium updating while the other one is used for updating the size of the gradient in the gradient descent algorithm. α usually is a number selected from 0 to 1, and

$$\frac{\partial E}{\partial w}$$

is a gradient of the error function vs. the weight. During the error feedback process, it is required to find the partial derivative

$$\frac{\partial E}{\partial w}$$

of the output with respect to the weight. Due to the backpropagation, it is required to obtain a partial derivative of the error with respect to the output, referring to the following formula (6).

$$\frac{\partial E}{\partial {O}_{j}} = 2 ( {O}_{j} - {t}_{j} ) \qquad ( 6 )$$

Then, in a backward link, the output depends on an output value of the activation function. Formula (7) is obtained by the activation function on the basis of the weight.

$$\frac{Δ {O}_{j}}{Δ {w}_{ji}} = \frac{\partial {O}_{j}}{Δ {A}_{j}} \frac{Δ {A}_{j}}{Δ {w}_{ji}} = {O}_{j} ( 1 - {O}_{j} ) {x}_{j} \qquad ( 7 )$$

In accordance with the formulae (6) and (7), using a chain rule of derivation, a derivative of the output with respect to the weight may be deduced, as shown by the following formula.

$$\frac{Δ E}{Δ {w}_{ji}} = \frac{\partial E}{Δ {O}_{j}} \frac{Δ {O}_{j}}{Δ {w}_{ji}} = 2 ( {O}_{j} - {t}_{j} ) {O}_{j} ( 1 - {O}_{j} ) {x}_{j}$$

In conclusion, the update of the weight may be obtained, as shown by the following formula (8):

Δwⱼᵢ =2η(Oⱼ−tⱼ)Oⱼ(1−Oⱼ)xⱼ (8)

According to the above-described algorithm deduction process, the core lies in that the process is performed using the random gradient descent algorithm. The backpropagation process is the key of the BP network. The gradient descent is employed from the output layer to the input layer to obtain the current optimal value, until all weights of the network are updated, that is, both the input weight matrix and the output weight matrix are updated. Thus, one iteration is accomplished, and the algorithm is iterated until convergence, as shown in FIG. 4.

2. Prediction Stage

After training, the network may be applied in practices. The input samples are the name and category tag of a file clicked by the user, and the output training result is the category tag of a predicted film that the user likes. In the schematic diagram of the BP prediction network shown in FIG. 5, Xi denotes an input sample, Yi denotes an intermediate node, and Zi denotes the final output, wherein, Xi may be the name of the film clicked by the user, and the predicted type of a film that the user is interested in is output.

203: The predicted recommended film is fed back to the television terminal so as to recommend the recommended film to the user.

The record of films clicked by a user will be recorded and uploaded to a server. If the favorite type of the user is obtained through prediction, and when the system performs recommendation, the preference will be recorded, and the preferable type of the user will be recommended from the server. When it is embodied in a television of the user, the same type of films will be recommended on a search page.

In an optional implementation way, the implementation method of 202 is as follows:

training the view data according to a recommendation algorithm;

acquiring, according to a training result, a category tag of the recommended film having high correlation;

matching the acquired category tag with a preset category tag in a film library; and

using the film, whose matching degree meets a preset recommendation standard value, as the recommended film having high correlation with the view data.

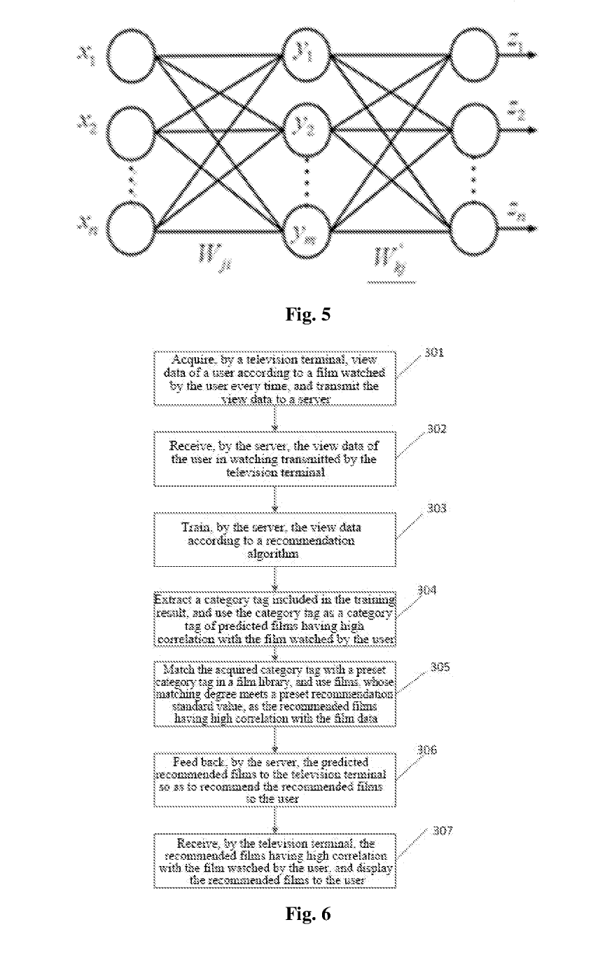

The detail specific implementation process of 202 may refer to the embodiment shown in FIG. 6.

As shown in FIG. 6, according to the methods shown in FIG. 1 and FIG. 2, the embodiment specifically provides a method for displaying play content on a smart television, including the following steps.

301: a television terminal acquires view data of a user according to a film watched by the user every time, and transmits the view data to a server.

302: the server receives the view data of the user in watching transmitted by the television terminal.

At present, a user has an account number. The view data of the user may be acquired according to the account number. For example, when the user's network is idle, the view data of clicked films are regularly transmitted to the network and then returned to the server over the network. The server will collect the data and then extracts the category tag, which is a tag marked on the film in advance. To use the category tag as the classification basis, for example, for “Monster Hunt”, three tags “costume”, “fantasy” and “comedy” are marked in advance, so the three tags are used as sample features for prediction.

303: the server trains the view data according to a recommendation algorithm.

Specifically, with regard to the name of the film watched by the user every time and the category tag of the film, the name of the film and the category tag of the film are used as an input sample, and then the input sample is input into the recommendation algorithm to obtain an output result, wherein use a process of obtaining an output result as a training process.

When the output result obtained after multiple training processes meets a preset prediction standard value, the corresponding output result is used as a training result, wherein the training result includes the category tag.

For example, the obtained view data are learned and trained by using the recommendation algorithm, and then the name and category tag of the film are input, and the name and category tag of the film are corresponded to serve as one-to-one corresponding training data. The obtained view data as a sample are input into the recommendation algorithm. One output will be obtained after one sample is input. The process of inputting and obtaining an output every time is a training. The output result/training result includes: the type and score of a film. One output will be obtained after every time of sample input and a plurality of outputs will be obtained after multiple times of sample input. The accuracy of the recommendation algorithm may be improved by multiple times of training.

The accuracy is improved because, every time of output is a numerical value obtained through once calculation, then the numerical value is subtracted from a preset target value to obtain an error, and the error is optimized through the error backpropagation process so that the error is reduced to a preset smaller prediction standard threshold. At this time, it is considered that a precision network, i.e., a prediction relation between the input sample film and the category to which the sample film belongs, is obtained. As the training process is performed in the server, there is no working pressure to the television of the user.

304: the category tag included in the training result is extracted, and the category tag is used as a category tag of predicted films having high correlation with the film watched by the user.

305: the acquired category tag is matched with a preset category tag in a film library, and the film or films, whose matching degree meets a preset recommendation standard value, are used as the recommended film or films having high correlation with the film data.

The category tag learned according to the view data of the user is matched with the classification of a target film library. As there may be a plurality of acquired category tags and each category is not necessarily matched, scoring is performed according to the result of matching. Films having a score greater than the preset recommendation standard value are regarded as films having high correlation, and the top n films having highest correlation are regarded as recommended film.

It is to be noted that, in the solution of this embodiment, it is required to classify films in the target film library before the training. That is, on the service terminal, the films in the target film library are marked with category tags in advance, and then classified according to the category tags to obtain a relatively initial classification network.

306: the server feeds back the predicted recommended film to the television terminal so as to recommend the recommended film to the user.

307: the television terminal receives the recommended film, having high correlation with the film watched by the user, fed back by the server, and displays the recommended film to the user.

In the method provided by this embodiment, the accuracy of prediction may be improved by training the recommendation algorithm. The more the input sample data is, the more accurate the trained algorithm is. Moreover, the more detailed the predicted category is, and the higher the accuracy of recommendation is.

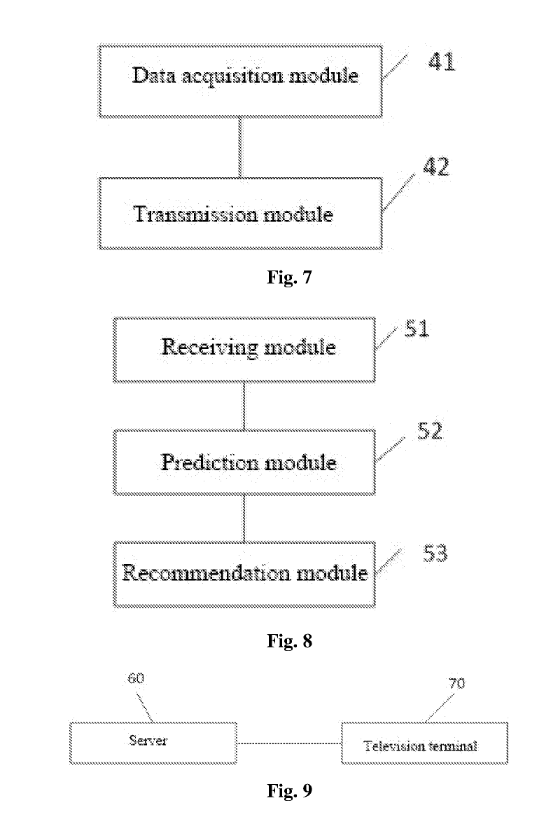

To implement the methods on the television terminal in the embodiments shown in FIGS. 1 and 6, the embodiment provides an apparatus for displaying play content on a smart television. As shown in FIG. 7, the apparatus includes: a data acquisition module 41 and a transmission module 42.

The data acquisition module 41, configured to acquire view data of a user according to a film watched by the user every time. The transmission module 42, configured to transmit the view data to a server.

Optionally, the apparatus further includes: a receiving module, configured to receive recommended film, having high correlation with the film watched by the user, fed back by the server, and a display module, configured to display the recommended film to the user.

The apparatus provided by the embodiment in FIG. 7 is suitable for being mounted on a television terminal, or is a Television or a set-top-box.

Correspondingly, to implement the methods on the server in the embodiments shown in FIGS. 2 and 6, the embodiment provides an apparatus for displaying play content on a smart television. As shown in FIG. 8, the apparatus includes: a receiving module 51, configured to receive view data of a user in watching transmitted by a television terminal; a prediction module 52, configured to predict, according to the view data, recommended film having high correlation with the view data; a recommendation module 53, configured to feed back the predicted recommended film to the television terminal so as to recommend the recommended film to the user.

Wherein, the prediction module 52 includes: a training unit, configured to train the view data according to a recommendation algorithm, a result acquisition module, configured to acquire a category tag of the recommended film having high correlation according to a training result, and a matching unit, configured to match the acquired category tag with a preset category tag in a film library, and use films, whose matching degree meets a preset recommendation standard value, as the recommended film having high correlation with the film data.

Wherein, the film data includes the name of a film watched by the user every time and a category tag of the film. Correspondingly, the training unit is specifically configured to, with regard to the name of the film watched by the user every time and the category tag of the film, use the name of the film and the category tag of the film as an input sample and then input the input sample into the recommendation algorithm to obtain an output result, wherein use a process of obtaining an output result as a training process; and, use the corresponding output result as the training result when the output result obtained after multiple training processes meets the preset prediction standard value, wherein the training result includes the category tag.

The apparatus provided by the embodiment in FIG. 8 is suitable for being mounted on a server, or is a server. The apparatuses provided by the embodiment in FIGS. 7 and 8 may implement the above-described method embodiments, and the specific implementation principle and technical effects may refer to the above-described method embodiments, and will not be repeated in the embodiment.

As shown in FIG. 9, the embodiment proceeds to provide system for displaying play content on a smart television, including a server 60 and a television terminal 70, wherein the server includes the apparatus in the embodiment shown in FIG. 8, and the television terminal 7 includes the apparatus in the embodiment shown FIG. 7. The specific structure and functions will not be repeated here.

The present disclosure provides a non-transitory computer-readable storage medium storing executable instructions that, when executed by an electronic device, cause the electronic device to perform any methods in the above-mentioned embodiments.

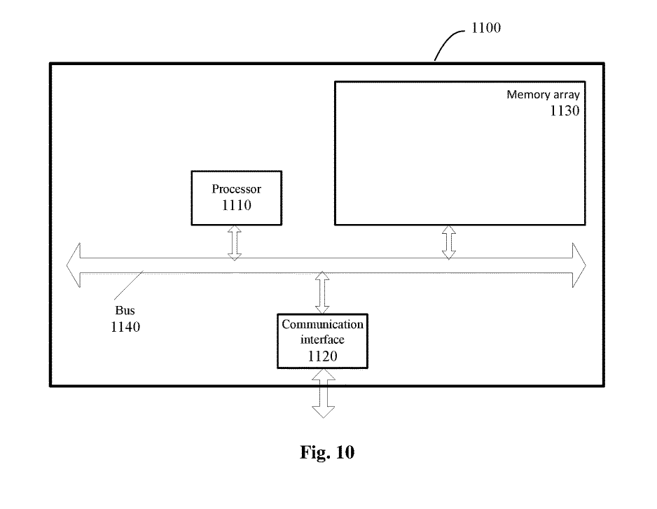

FIG. 10 shows a structural block diagram of an apparatus for displaying play content on a smart television according to another embodiment of the present disclosure. The apparatus 1100 for displaying play content on a smart television may be a host server having computing capability, a personal computer (PC), a portable computer or terminal, or the like. The specific implementation of a computation node is not limited by the specific embodiments of the present disclosure.

The apparatus 1100 for displaying play content on a smart television includes a processor 1110, a communications interface 1120, a memory (memory array) 1130 and a bus 1140, wherein, the processor 1110, the communications interface 1120 and the memory 1130 intercommunicate with each other through the bus 1140.

The communications interface 1120 is configured to communicate with a network element, wherein the network element includes, for example, a virtual machine management center, a shared storage or the like.

The processor 1110 is configured to execute programs. The processor 1110 may be a Central Processing Unit (CPU), an Application Specific Integrated Circuit (ASIC), or one or more integrated circuits configured to implement the embodiments of the present disclosure.

The memory 1130 is configured to store files. The memory 1130 may include a high-speed RAM memory, or may also include a non-volatile memory, for example, at least one magnetic disk memory. The memory 1130 may also be a memory array. The memory 1130 may also be divided into blocks, and the blocks may be combined according to certain rules to form a virtual volume.

In one possible implementation way, the programs may be program codes containing computer operation instructions. The programs may be specifically executed to: receive view data of a user in watching transmitted by a television terminal; predict, according to the view data, recommended film having high correlation with the view data; and feedback the predicted recommended film to the television terminal so as to recommend the recommended film to the user.

In one possible implementation way, the predicting, according to the view data, recommended film having high correlation with the view data includes: training the view data according to a recommendation algorithm; acquiring, according to a training result, a category tag of the recommended film having high correlation; matching the acquired category tag with a preset category tag in a film library; and using the film, whose matching degree meets a preset recommendation standard value, as the recommended film having high correlation with the film data.

In one possible implementation way, the view data includes the name of a film watched by the user every time and a category tag of the film; and, the training the view data according to a recommended algorithm includes: using the name of the film and the category tag of the film as an input sample and then inputting the input sample into the recommendation algorithm to obtain an output result, according to the name of the film watched by the user every time and the category tag of the film, wherein use a process of obtaining an output result as a training process; and using the corresponding output result as the training result when the output result obtained after multiple training processes meets the preset prediction standard value, wherein the training result includes the category tag.

The above-mentioned product can execute the method provided by the embodiments of the present disclosure and has corresponding functional modules executing the method and beneficial effects. The technical details not described in the embodiment in detail are available with reference to the method provided by the embodiments of the present disclosure.

The electronic equipment in the embodiments of the present disclosure exists in many forms, including but not limited to:

(1) Mobile communication equipment: this type of equipment is featured with a mobile communication function, and is mainly used for providing voice and data communication. These terminals include: a smartphone (e.g. iPhone), a multimedia phone, a functionality phone, and a low-end phone, and the like.

(2) Ultra mobile personal computer equipment: this type of equipment belongs to the range of personal computers, and is provided with computation and processing functions, and typically has a mobile internet characteristic. These terminals include: PDA, MID and UMPC equipment, and the like, such as iPad.

(3) Portable recreation equipment: this type of equipment can display and display multimedia contents and include: voice and audio players (such as iPod), handheld game players, e-books, intelligent toys and portable vehicle navigation equipment.

(4) Servers: apparatus can provide computing service, and servers include: processors, rigid disks, memories, system buses and the like, architecture of the servers is similar to that of a general-purpose computer, however, due to requirement for providing high-quality and reliable service, the requirements on processing capability, stability, reliability, safety, expandability, manageability and other aspects are higher.

(5) Other electronic devices with a data interaction function.

The device embodiments described above are merely exemplary, wherein units described as separated components can be or cannot be separated physically, components displayed as units can be or cannot be physical units, namely can be located in one place, or can be distributed on multiple network units. The object of the solution of the embodiments can be achieved by selecting part or all of modules according to practical demands.

Based on the above description of the embodiments, it can be clearly appreciated by those skilled in the art that the embodiments can be implemented in a way of combination of software and a universal hardware platform or through hardware certainly. Based on such understanding, the nature of the above-mentioned technical solution or its part making contribution to relevant technology can be embodied in form of software. The computer software product can be stored in a computer readable medium, such as ROM/RAM, a disk, CD, etc. and comprises a plurality of instructions for enabling one set of computer equipment (which may be a personal computer, a server or network equipment, etc.) to execute the method described in all embodiments or in part of an embodiment.

Finally, it should be noted that the above-mentioned embodiments are only used for explaining the technical solution of this application but not for limiting it. Even though this application has been described in detail with reference to the aforesaid embodiments, it should be understood that those skilled in the art still can modify the technical solutions disclosed in the above-mentioned embodiments or make equivalent substitutions to part of technical features; and these modifications or substitutions will not depart the corresponding technical solutions essentially from the spirit and scope of the technical solutions of all embodiments of this application.

What is claimed is:

1. A method for displaying play content on a smart television, executed by a server, the said method comprising:
receiving view data of a user in watching transmitted by a television terminal;
predicting, according to the view data, a recommended film having high correlation with the view data; and
feeding back the predicted recommended film to the television terminal so as to recommend the recommended film to the user.

2. The method according to claim 1, wherein the predicting, according to the view data, a recommended film having high correlation with the view data comprises:
training the view data according to a recommendation algorithm;
acquiring, according to a training result, a category tag of the recommended film having high correlation;
matching the acquired category tag with a preset category tag in a film library; and
using a film, whose matching degree meets a preset recommendation standard value, as the recommended film having high correlation with the film data.

3. The method according to claim 2, wherein the film data comprises the name of a film watched by the user every time and a category tag of the film; and the training the film data according to a recommendation algorithm comprises:
using the name of the film and the category tag of the film as one input sample and inputting the input sample into the recommendation algorithm to obtain one output result, according to the name of the film watched by the user every time and the category tag of the film, wherein use a process of obtaining one output result as one training process; and
using the corresponding output result as the training result when the output result obtained after multiple training processes meets a preset prediction standard value, wherein the training result comprises the category tag.

4. The method according to claim 2, wherein the recommendation algorithm comprises the neural network algorithm.

5. The method according to claim 2, wherein the recommendation algorithm comprises the backpropagation algorithm.

6. An electronic device, comprising:
at least one processor; and
a memory communicably connected with the at least one processor for storing instructions executable by the at least one processor, wherein execution of the instructions by the at least one processor causes the at least one processor to:
receive view data of a user in watching transmitted by a television terminal;
predict, according to the view data, a recommended film having high correlation with the view data; and
feedback the predicted recommended film to the television terminal so as to recommend the recommended film to the user.

7. The electronic device according to claim 6, wherein execution of the instructions by the at least one processor causes the at least one processor to:
train the view data according to a recommendation algorithm;
acquire, according to a training result, a category tag of the recommended film having high correlation;
match the acquired category tag with a preset category tag in a film library; and
use a film, whose matching degree meets a preset recommendation standard value, as the recommended film having high correlation with the film data.

8. The electronic device according to claim 7, wherein execution of the instructions by the at least one processor causes the at least one processor to:
use the name of the film and the category tag of the film as one input sample and input the input sample into the recommendation algorithm to obtain one output result, according to the name of the film watched by the user every time and the category tag of the film, wherein use a process of obtaining one output result as one training process; and
use the corresponding output result as the training result when the output result obtained after multiple training processes meets a preset prediction standard value, wherein the training result comprises the category tag.

9. The electronic device according to claim 7, wherein the recommendation algorithm comprises a neural network algorithm.

10. The electronic device according to claim 7, wherein the recommendation algorithm comprises a backpropagation algorithm.

11. A non-transitory computer-readable storage medium storing executable instructions that, when executed by an electronic device, cause the electronic device to:
receive view data of a user in watching transmitted by a television terminal;
predict, according to the view data, a recommended film having high correlation with the view data; and
feedback the predicted recommended film to the television terminal so as to recommend the recommended film to the user.

12. The non-transitory computer-readable storage medium according to claim 11, when execute the instructions cause the electronic device to:
train the view data according to a recommendation algorithm;
acquire, according to a training result, a category tag of the recommended film having high correlation;
match the acquired category tag with a preset category tag in a film library; and
use a film, whose matching degree meets a preset recommendation standard value, as the recommended film having high correlation with the film data.

13. The non-transitory computer-readable storage medium according to claim 12, wherein when execute the instructions cause the electronic device to:
use the name of the film and the category tag of the film as one input sample and input the input sample into the recommendation algorithm to obtain one output result, according to the name of the film watched by the user every time and the category tag of the film, wherein use a process of obtaining one output result as one training process; and
use the corresponding output result as the training result when the output result obtained after multiple training processes meets a preset prediction standard value, wherein the training result comprises the category tag.

14. The non-transitory computer-readable storage medium according to claim 12, wherein the recommendation algorithm comprises a neural network algorithm.

15. The non-transitory computer-readable storage medium according to claim 12, wherein the recommendation algorithm comprises a backpropagation algorithm.
